(19) United States
(12) Patent Application Publication
(10) Pub. No.: US 2021/0305818 A1
(43) Pub. Date: Sep. 30, 2021

(54) High Efficiency Bidirectional Charge Balancing of Battery Cells

(71) Applicant: pSemi Corporation, San Diego, CA (US)

(72) Inventors: David Andrew Kilshaw, Mortimer (GB); Antony Christopher Routledge, Oakley (GB); Nigel David Brooke, Chippenham (GB); Mark Moffat, Mortimer (GB)

(21) Appl. No.: 16/831,583

(22) Filed: Mar. 26, 2020

(51) Int. Cl. H02J 7/00

(52) U.S. Cl. CPC H02J 7/0018; H02J 7/0016

(57) ABSTRACT

A high efficiency concurrent bidirectional charge balancing circuit (BCBC) for battery balancing that does not require high voltage transistors and which automatically transfers charge from a higher voltage cell to a lower voltage cell within a battery pack of multiple series-connected cells using a bi-phase charge pump, which may be an adiabatic-enabled bi-phase charge pump. The BCBC requires no complex external control logic to determine how the BCBCs are to be connected, charge balancing is performed without disturbing the series connections of the cells in a battery pack, and there is constant charge balancing across the entire charge range of cells in a battery pack. Because each BCBC spans only two cells, the voltage across each BCBC is the sum of the voltages from only those two cells; accordingly, the BCBC scales up to a large number of cells without requiring increasingly larger and more expensive high voltage transistors.

### BACKGROUND

### (1) Technical Field

This invention relates to electrical battery management circuits and methods.

### (2) Background

Modern electrical and electronic products and systems, ranging from toys to cell phones to electric vehicles to battery backup systems, are often powered by a battery pack that includes multiple series-connected rechargeable battery cells, such as lithium ion rechargeable battery cells. The individual cells of a battery pack typically have somewhat different capacities and may be at different levels of state of charge. Such cell-to-cell differences may be due to manufacturing and/or assembly variances, different charging/discharging histories, different heat exposure history, etc.

In order to maximize battery cell and battery pack life and the amount of available charge, it is important to balance the charge between the cells without over-charging or undercharging the weakest cell. Balanced battery packs are the most efficient and safe method of storing energy. However, even if cell-to-cell differences are minimized or eliminated, battery pack cells are only completely balanced when all cells are fully charged—but a fully charged state is not a normal situation in many applications. For example, some renewable energy systems (e.g., solar farms with battery backup) may never actually achieve full charge for their battery pack cells. Accordingly, battery pack cells can get further and further out of balance until a full recharge is performed.

In order to maximize the service life of a battery pack of multiple cells, it is useful to provide a balancing circuit to minimize charge imbalance among battery pack cells. Without a balancing circuit, power draw from a battery ends when any one cell runs out of charge, even if other cells still retain charge. Further, even before power draw ceases, the battery pack stack voltage will reduce quickly. As one example for a particular battery pack, while the battery pack charge is between 100% and about 10%, the battery pack voltage will only vary by a small percentage; however, below about 10% of charge, the battery pack voltage will drop very quickly.

To achieve dynamic cell balance, a balance circuit should arrange for charge dissipation until cell voltages approximately match, or energy transfers from cells having a higher voltage level to cells having a lower voltage level. For example, FIG. 1 is a schematic diagram of a prior art battery charge balancing circuit that relies upon resistive charge dissipation. In the illustrated example, a battery pack 102 includes four battery cells S1-S4; in other embodiments, the number of cells may be less than or greater than four. Coupled in parallel with each battery cell S1-S4 is a corresponding resistive balancing circuit. The corresponding resistive balancing circuits include a corresponding resistor R1-R4 connected in series with a corresponding transistor M1-M4. A corresponding comparator COMP1-COMP4 controls switching the transistors M1-M4. A first input of each comparator COMP1-COMP4 is connected to a corresponding reference voltage V_{REF}N while a second input of each comparator COMP1-COMP4 is connected to a corresponding battery cell S1-S4. The output of each comparator COMP1-COMP4 is connected to the gate of a corresponding transistor M1-M4.

In operation, when the voltage across a battery cell S1-S4 exceeds the corresponding V_{REF}N as sensed by the corresponding comparator COMP1-COMP4, the corresponding transistor M1-M4 is turned ON (i.e., set to a conductive state) by the coupled comparator and excess charge in the triggering battery cell S1-S4 is dissipated in the corresponding resistor R1-R4.

As should be clear, the circuit shown in FIG. 1 is very inefficient, as energy is wasted in the resistors through heat. Such heat stresses the cells. Further, any imbalance at all results in wasted dissipated charge, and the battery pack self-discharges. In addition, dissipative balancing circuits may take a long time to achieve balance if the degree of imbalance among the cells of a battery pack is great and the balance current is low. Furthermore, cell S1 is at the highest potential so charge transfer can only go down the stack, from cell S1 to S2, from S2 to S3, and from S3 to S4. Thus, cell S1 cannot be charged from cell S4.

FIG. 2 is a schematic diagram of a prior art capacitive battery charge balancing circuit that relies upon charge transfer between battery cells. In the illustrated example, a battery pack 102 includes four battery cells S1-S4. Coupled in parallel with each battery cell S1-S4 is a switching array 104 including corresponding pairs of transistors having common gates controlled by trigger signals T1-T4. Each pair of triggerable transistors can be coupled to a transfer capacitor C_{T} through a transfer pair of transistors M+, M− controlled by a trigger signal T_{Xfer}. The transistors may be, for example, field effect transistors (FETs). A logic circuit 202 is coupled to voltage monitoring nodes D1-D5 that bracket each battery cell S1-S4, and can output any of the trigger signals T1-T4, T_{Xfer}. As should be clear to one of ordinary skill in the art, any battery cell S1-S4 can be independently coupled to the transfer capacitor C_{T} through the switching array 104 and transistors M+, M− by appropriate selection of the trigger signals T1-T4, T_{Xfer}.

In operation, the logic circuit 202 monitors the voltage across each battery cell S1-S4, and if a cell has excess voltage, that cell can be coupled to the transfer capacitor C_{T} by outputting appropriate trigger signals T1-T4, T_{Xfer}. Excess charge from the coupled battery cell transfers to the transfer capacitor C_{T}, and then the coupled battery cell is disconnected by the logic circuit 202. Thereafter, the charge on the transfer capacitor C_{T} can be transferred to any cell having a lower voltage (generally, the cell having the lowest amount of charge) by outputting appropriate trigger signals T1-T4, T_{Xfer} from the logic circuit 202.

The circuit shown in FIG. 2 provides constant balancing across an entire charge range of cells, and a significant amount of energy is recycled from higher charge cells into lower charge cells (this assumes that cell capacitances are matched, otherwise energy recycling is from higher voltage cells into lower voltage cells). However, there is a trade-off between the ON resistance, R_{ON}, of the transistors and the current flow from the battery cells S1-S4 to the transfer capacitor C_{T}. The lower the R_{ON}, the shorter the time that current flows but the higher the current spike. Hence the circuit is only about 60% efficient. Further, all transistors in the circuit need to be able to withstand the entire voltage across the battery pack 102, and the voltage increases as the number of cells in the battery pack 102 increases. High voltage transistors increase cost and consume more integrated circuit die area, and the overall circuit in FIG. 2 does not scale up well as the number of cells increases.

Accordingly, there is a need for a battery balancing circuit and method having high efficiency that also do not require high voltage transistors. The present invention meets this need and provides additional benefits.

### SUMMARY

The present invention encompasses circuits and methods for battery balancing having high efficiency that also do not require high voltage transistors. More particularly, embodiments of the present invention include a high efficiency concurrent bidirectional charge balancing circuit that automatically transfers charge from a higher voltage battery cell to a lower voltage battery cell within a battery pack of multiple series-connected cells using a bi-phase charge pump, which preferably is an adiabatic-enabled bi-phase charge pump.

In one embodiment, coupled in parallel with each pair of adjacent battery cells of a battery pack are corresponding concurrent bidirectional charge balancing circuits (BCBCs). To significantly improve efficiency, some embodiments of the BCBCs have an adiabatic architecture that avoids excessive dissipative losses. Each BCBC includes a balancing circuit coupled to a clock source that generates non-overlapping two-phase clock waveforms P1 and P2. During time periods determined by P1 and P2, internal charge transfer subcircuits within each BCBC are separately connected to or disconnected from a pair of corresponding coupled cells Sx.

For example, in a first state, a first internal charge transfer subcircuit within a BCBC is coupled to its “top” cell S_{T} and decoupled from its “bottom” cell S_{B}. Cell S_{T} transfers charge to the first internal charge transfer subcircuit if the first internal charge transfer subcircuit is at a lower voltage; conversely, the first internal charge transfer subcircuit transfers charge to cell S_{T} if cell S_{T} is at a lower voltage. Meanwhile, a second internal charge transfer subcircuit is coupled to cell S_{B} and decoupled from cell S_{T}. Cell S_{B} transfers charge to the second internal charge transfer subcircuit if the second internal charge transfer subcircuit is at a lower voltage; conversely, the second internal charge transfer subcircuit transfers charge to cell S_{B} if cell S_{B} is at a lower voltage. Thus, the first and second internal charge transfer subcircuits move charge to balance the voltage of cells S_{T} and S_{B}.

Conversely, in a second state, the first internal charge transfer subcircuit within the BCBC is coupled to its “bottom” cell S_{B} and decoupled from its “top” cell S_{T}. Cell S_{B} transfers charge to the first internal charge transfer subcircuit if the first internal charge transfer subcircuit is at a lower voltage; conversely, the first internal charge transfer subcircuit transfers charge to cell S_{B} if cell S_{B} is at a lower voltage. Meanwhile, the second internal charge transfer subcircuit is coupled to cell S_{T} and decoupled from cell S_{B}. Cell S_{T} transfers charge to the second internal charge transfer subcircuit if the second internal charge transfer subcircuit is at a lower voltage; conversely, the second internal charge transfer subcircuit transfers charge to cell S_{T} if cell S_{T} is at a lower voltage. Again, the first and second internal charge transfer subcircuits move charge to balance the voltage of cells S_{B} and S_{T}.

The BCBC architecture automatically recycles energy from higher voltage cells into lower voltage cells across all cells in a battery pack under any charge condition. The BCBC architecture also requires no complex external control logic to determine how the BCBCs are to be connected, charge balancing is performed without disturbing the series connections of the cells in a battery pack, and there is continuous charge balancing across the entire charge range of cells in a battery pack when desired (typically at zero load or light load, to avoid issues with differences in output resistance among the cells).

Of further note, because each BCBC spans only two adjacent cells S_{T}, S_{B}, the voltage across each BCBC is the sum of the voltages from only those two cells (rather than the sum of the voltages of all the cells within a battery pack, as with conventional capacitive balancing circuits). Accordingly, the BCBC architecture scales up to a large number of cells without requiring increasingly larger and more expensive high voltage transistors.

The details of one or more embodiments of the invention are set forth in the accompanying drawings and the description below. Other features, objects, and advantages of the invention will be apparent from the description and drawings, and from the claims.

### DESCRIPTION OF THE DRAWINGS

FIG. 1 is a schematic diagram of a prior art battery charge balancing circuit that relies upon resistive charge dissipation.

FIG. 2 is a schematic diagram of a prior art capacitive battery charge balancing circuit that relies upon charge transfer between battery cells.

FIG. 3A is a block diagram of a possible circuit architecture for one embodiment of the present invention.

FIG. 3B is a schematic of a first circuit for implementing a concurrent bidirectional charge balancing circuit.

FIG. 3C is a schematic diagram of the circuit of FIG. 3B with the switches set to a first state.

FIG. 3D is a schematic diagram of the circuit of FIG. 3B with the switches set to a second state.

FIG. 3E is a schematic of a circuit for implementing an adiabatic-enabled concurrent bidirectional charge balancing circuit.

FIG. 4 is a set of graphs of voltage as a function of time for a conventional capacitive circuit (upper portion of the graph) and for an embodiment of the present invention (lower portion of the graph).

FIG. 5 is a graph of non-overlapping two-phase (P1, P2) clock waveforms suitable for controlling the operation of the concurrent bidirectional charge balancing circuits of FIGS. 3A and 3B.

FIG. 6 is a schematic diagram of one circuit capable of generating the non-overlapping two-phase clock waveforms shown in FIG. 5.

FIG. 7 is a process flow chart showing a first method of bidirectionally balancing charge and/or voltage between a pair of series-connected adjacent battery cells, including shuttling excess charge between the pair of adjacent battery cells using a concurrent bidirectional charge transfer circuit coupled in parallel with such pair of adjacent battery cells.

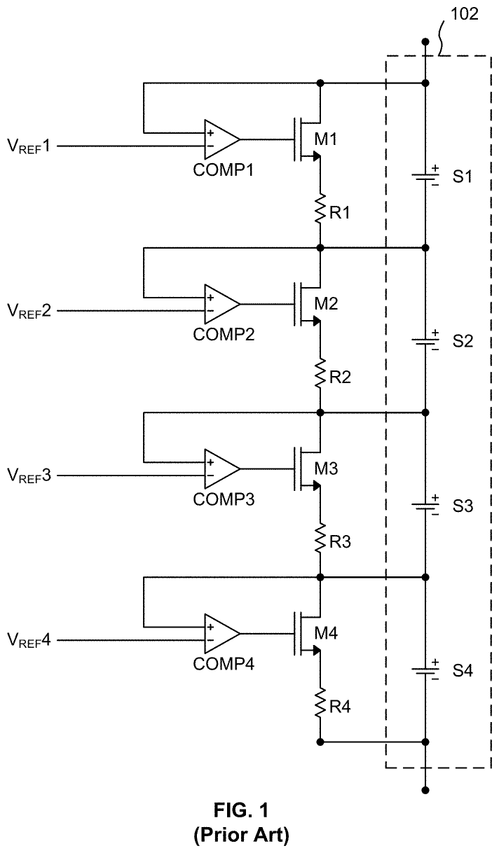

Like reference numbers and designations in the various drawings indicate like elements.

### DETAILED DESCRIPTION

The present invention encompasses circuits and methods for battery balancing having high efficiency that also do not require high voltage transistors. More particularly, embodiments of the present invention include a high efficiency concurrent bidirectional charge balancing circuit that automatically transfers charge from a higher voltage battery cell to a lower voltage battery cell within a battery pack of multiple series-connected cells using a bi-phase charge pump, which preferably is an adiabatic-enabled bi-phase charge pump.

General Circuit Architecture and Operation

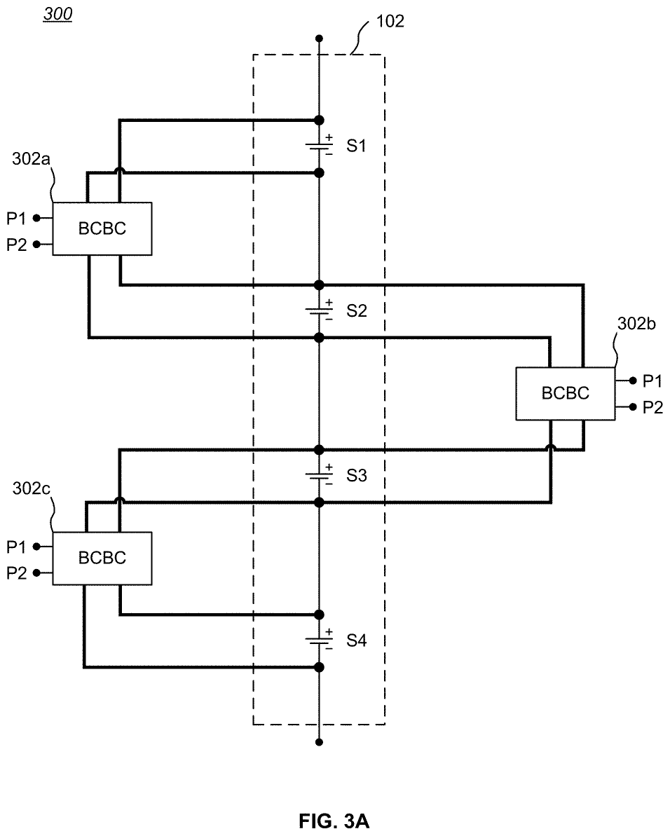

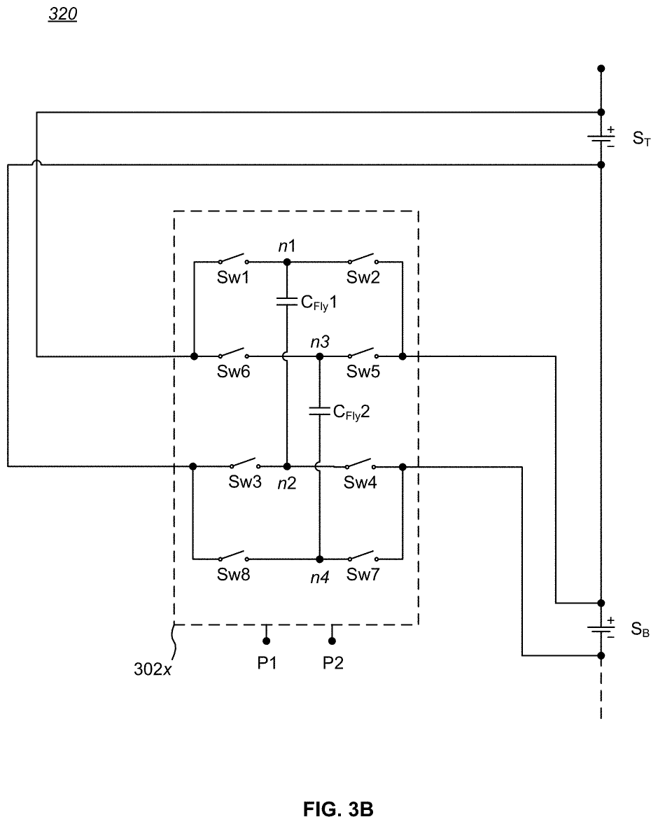

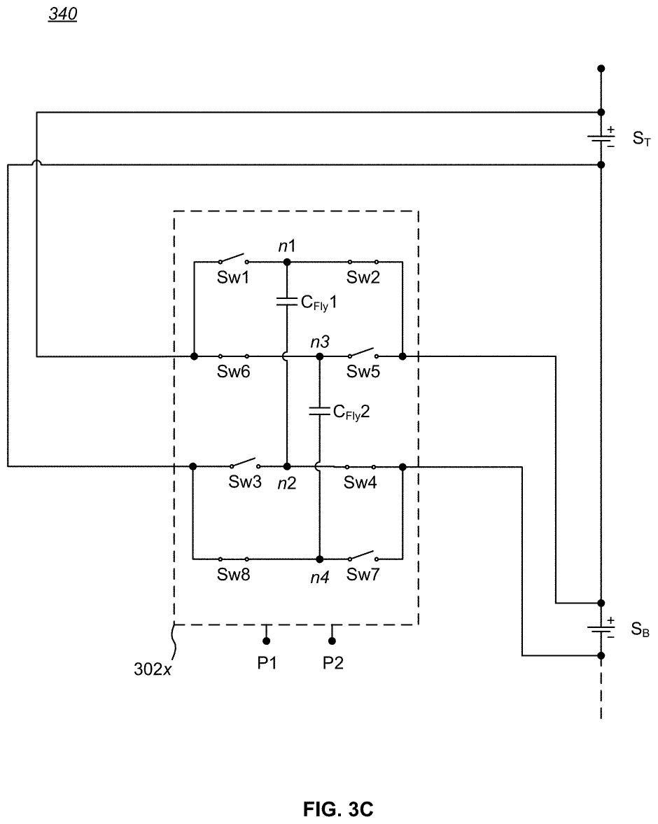

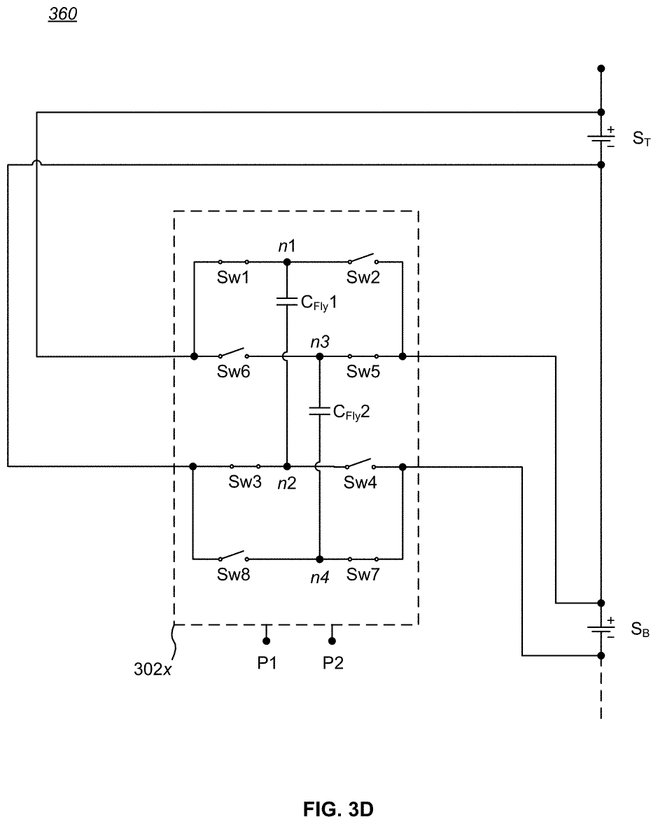

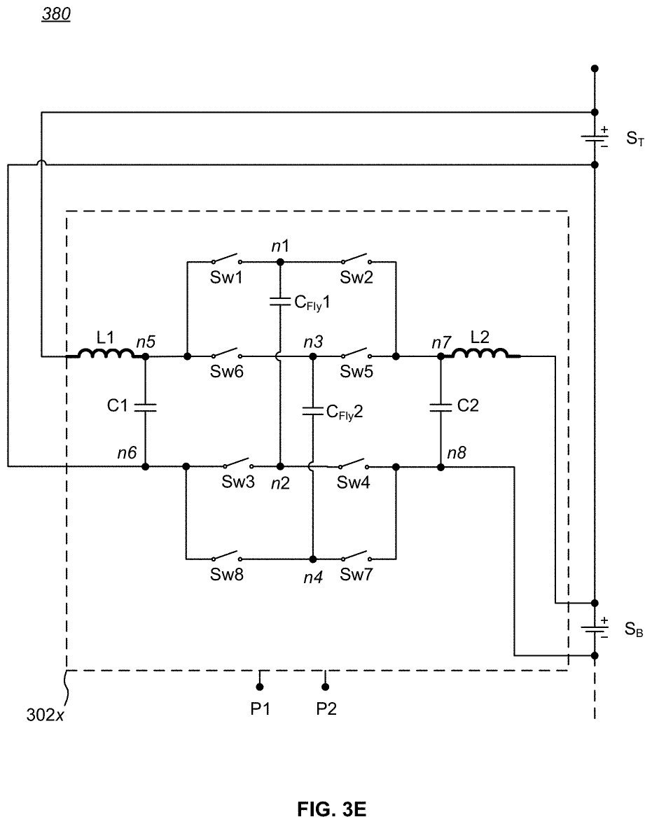

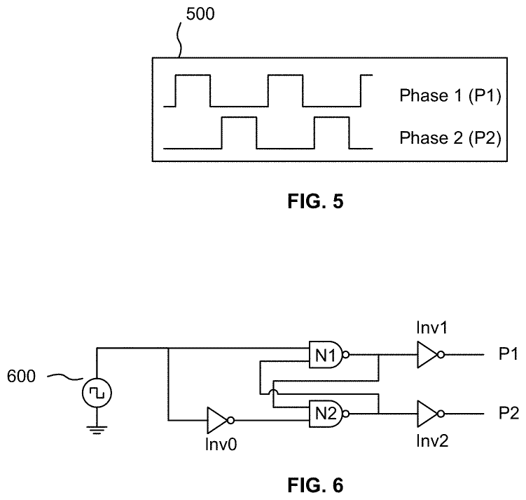

FIG. 3A is a block diagram of a circuit architecture 300 for one embodiment of the present invention. In the illustrated example, a battery pack 102 includes four series-connected battery cells S1-S4; in other embodiments, the number of cells may be less than or greater than four. Coupled in parallel with each pair of adjacent battery cells S1-S4 are corresponding concurrent bidirectional charge balancing circuits 302x; thus, for N cells Sx, there are N−1 concurrent bidirectional charge balancing circuits (BCBCs) 302x. Each BCBC 302x includes a balancing circuit coupled to a clock source that generates non-overlapping two-phase clock waveforms P1 and P2 (see description below of FIGS. 5 and 6 for greater detail). Alternatively, each BCBC 302x may include an internal circuit which, when enabled by a global “enable” signal to all BCBCs 302x, generates non-overlapping two-phase clock waveforms P1 and P2. To significantly improve efficiency, some embodiments of the BCBCs have an adiabatic architecture that avoids excessive dissipative losses.

During time periods determined by P1 and P2, internal charge transfer subcircuits within each BCBC 302x are separately connected to or disconnected from a pair of corresponding coupled cells Sx. For example, in a first state when P1 is a logic “1” and P2 is a logic “0”, then a first internal charge transfer subcircuit within BCBC 302a is coupled by internal switches to its top cell S1 and decoupled from its bottom cell S2. The top cell S1 transfers charge to the first internal charge transfer subcircuit if the first internal charge transfer subcircuit is at a lower voltage; conversely, the first internal charge transfer subcircuit transfers charge to top cell S1 if top cell S1 is at a lower voltage. Meanwhile, a second internal charge transfer subcircuit within BCBC 302a is coupled by internal switches to its bottom cell S2 and decoupled from its top cell S1. The bottom cell S2 transfers charge to the second internal charge transfer subcircuit if the second internal charge transfer subcircuit is at a lower voltage; conversely, the second internal charge transfer subcircuit transfers charge to bottom cell S2 if bottom cell S2 is at a lower voltage. Thus, the first and second internal charge transfer subcircuits within BCBC 302a move charge to balance the voltage of cells S1 and S2.

Conversely, in a second state, when P1 is a logic “0” and P2 is a logic “1”, then the first internal charge transfer subcircuit within BCBC 302a is coupled by internal switches to its bottom cell S2 and decoupled from its top cell S1. The bottom cell S2 transfers charge to the first internal charge transfer subcircuit if the first internal charge transfer subcircuit is at a lower voltage; conversely, the first internal charge transfer subcircuit transfers charge to bottom cell S2 if bottom cell S2 is at a lower voltage. Meanwhile, the second internal charge transfer subcircuit is coupled by internal switches to its top cell S1 and decoupled from its bottom cell S2. The top cell S1 transfers charge to the second internal charge transfer subcircuit if the second internal charge transfer subcircuit is at a lower voltage; conversely, the second internal charge transfer subcircuit transfers charge to top cell S1 if top cell S1 is at a lower voltage. Again, the first and second internal charge transfer subcircuits within BCBC 302a move charge to balance the voltage of cells S2 and S1.

The circuit architecture shown in FIG. 3A automatically recycles energy from higher voltage cells into lower voltage cells across all cells Sx in the battery pack 102 under any charge condition. Thus, for example, if the charge across cells S1-S4 is initially distributed such that S1>S2>S3>S4, then BCBC 302a will shuttle excess charge from S1 to S2, BCBC 302b will shuttle excess charge from S2 to S3, and BCBC 302c will shuttle excess charge from S3 to S4, in “bucket brigade” fashion, thus eventually balancing the entire battery pack 102. The same outcome occurs regardless of which cell or cells S1-S4 have excess charge, since the BCBCs 302x are bidirectional.

The circuit architecture shown in FIG. 3A requires no complex external control logic to determine how the BCBCs 302x are to be connected, charge balancing is performed without disturbing the series connections of the cells Sx in the battery pack 102, and there is constant charge balancing across the entire charge range of cells Sx in the battery pack 102 while the BCBCs are enabled (typically at zero load or light load, to avoid issues with differences in output resistance among the cells).

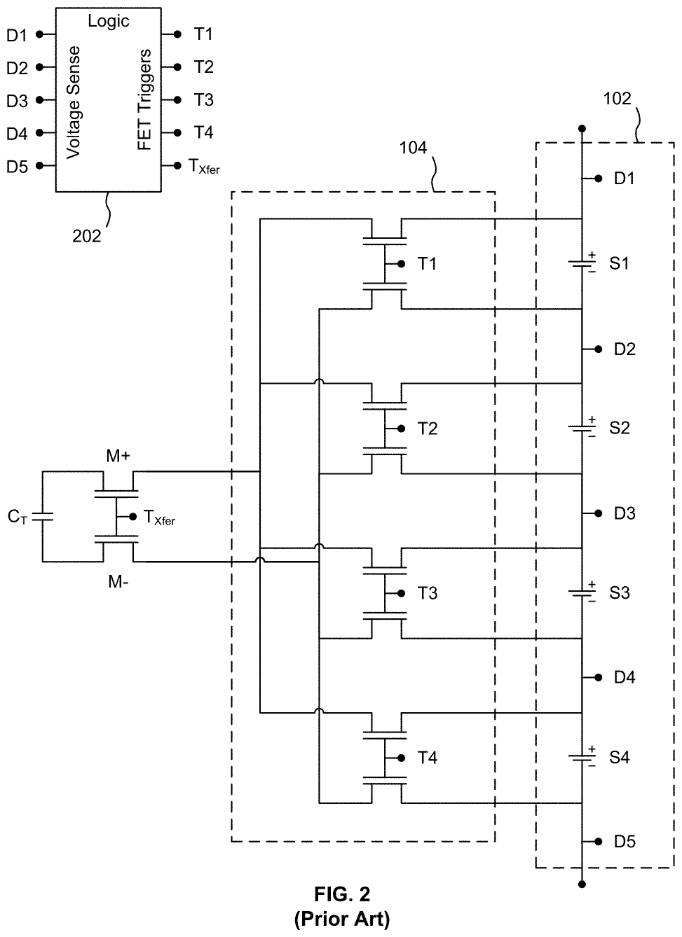

Of further note, because each BCBC 302x spans only two adjacent cells Sx, the voltage across each BCBC 302x is the sum of the voltages from only those two cells (rather than the sum of the voltages of all the cells Sx within the battery pack 102, as with the conventional circuit shown in FIG. 2). Accordingly, the configuration shown in FIG. 3A scales up to a large number of cells Sx without requiring increasingly larger and more expensive high voltage transistors.

Non-Adiabatic Charge Transfer Embodiment

FIG. 3B is a schematic of a first circuit 320 for implementing a concurrent bidirectional charge balancing circuit 302x. In the illustrated example, the BCBC 302x is coupled in parallel with a top cell S_{T} and a bottom cell S_{B}. The BCBC 302x is also coupled across both the positive and negative terminals of each coupled cell S_{T}, S_{B}.

In the illustrated embodiment, the first circuit 320 includes two interconnected charge transfer subcircuits. A first charge transfer subcircuit comprises switches Sw1, Sw2, Sw5, Sw6 and a first fly capacitor C_{FLY}1. A second charge transfer subcircuit comprises switches Sw3, Sw4, Sw7, Sw8 and a second fly capacitor C_{FLY}2. Switches Sw1, Sw6 are connected to the positive terminal of cell S_{T}, and switches Sw2, Sw5 are connected to the positive terminal of cell S_{B}. Switches Sw3, Sw8 are connected to the negative terminal of the cell S_{T}, and switches Sw4, Sw7 are connected to the negative terminal of cell S_{B}. The first fly capacitor C_{FLY}1 is coupled to a node n1 between switches Sw1, Sw2 and to a node n2 between switches Sw3, Sw4. The second fly capacitor C_{FLY}2 is coupled to a node n3 between switches Sw5, Sw6 and to a node n4 between switches Sw7, Sw8.

Of note is that the BCBC 302x includes two charge transfer subcircuits, which allows concurrent bidirectional operation with no “OFF” time with respect to charge transfers, and thus provides fast cell balancing. In contrast, if only one charge transfer subcircuit were used, the subcircuit would charge a particular cell only 50% of the time (i.e., cell S_{T} would be idle while cell S_{B} was charging, and vice versa). Fast cell balancing is of particular benefit since the BCBC 302x may only have limited time to charge balance.

As should be appreciated, the connections of the BCBC 302x to the positive and negative terminals of cells S_{T} and S_{B} can be reversed, and the designations “top” and “bottom” are for convenience of reference to the bracketing cells S_{T}, S_{B} to which the BCBC 302x is connected. In a specific embodiment, the fly capacitors C_{FLY}1, C_{FLY}2 may be about 1 μF each. The fly capacitors C_{FLY}1, C_{FLY}2 may be external to an integrated circuit (IC) implementation of the switches Sw1-Sw8 of the BCBC 302x or may be fabricated as part of the same IC. The switches Sw1-Sw8 shown in FIG. 3B may be implemented in any type of suitable technology, including MEMS relays and transistors, particularly FETs and especially MOSFETs. In some cases, in order to withstand high voltages, multiple FETs and MOSFETs may be connected in series, or “stacked”, and configured with commonly controlled gates to operate as a single switch.

The clock waveforms P1, P2, are coupled to and control particular switches; one assignment of clock waveforms to switches is shown in TABLE 1 below. Note that there is a blanking interval between logic “1” states for the clock waveforms P1, P2 so that both waveforms present as a logic “0” at the same time, meaning that all switches Sw1-Sw8 are OFF during the blanking interval. This ensures that cells S_{B} and S_{T} are never directly connected to each other at the same time.

TABLE 1

| Waveform | Closed Switches |
|---|---|
| P1 | Sw2, Sw4, Sw6, Sw8 |
| P2 | Sw1, Sw3, Sw5, Sw7 |

When switches Sw1-Sw8 are controlled by waveforms P1, P2, the switches Sw1-Sw8 and fly capacitors C_{FLY}1, C_{FLY}2 function as a pair of interconnected bi-phase bidirectional concurrent charge transfer circuits.

In operation, the first charge transfer subcircuit of the BCBC 302x of FIG. 3B is alternately coupled to cell S_{T} and cell S_{B}. At the same time, the second charge transfer subcircuit of the BCBC 302x is alternately (and oppositely) coupled to cell S_{B} and cell S_{T}.

For example, FIG. 3C is a schematic diagram 340 of the circuit of FIG. 3B with the switches set to a first state. In the first state, P1 is a logic “1” and P2 is a logic “0”, and accordingly switches Sw2, Sw4, Sw6, Sw8 are closed and switches Sw1, Sw3, Sw5, Sw7 are open. The following connections and disconnections are formed:

(1) the positive terminal of cell S_{T} is disconnected from node n1 because switch Sw1 is open and the negative terminal of cell S_{T} is disconnected from node n2 because switch Sw3 is open, thereby isolating fly capacitor C_{FLY}1 from cell S_{T};

(2) the positive terminal of cell S_{B} is connected to node n1 through switch Sw2 and the negative terminal of cell S_{B} is connected to node n2 through switch Sw4, thereby connecting fly capacitor C_{FLY}1 across cell S_{B};

(3) the positive terminal of cell S_{T} is connected to node n3 through switch Sw6 and the negative terminal of cell S_{T} is connected to node n4 through switch Sw8, thereby connecting fly capacitor C_{FLY}2 across cell S_{T};

(4) the positive terminal of cell S_{B} is disconnected from node n3 because switch Sw5 is open and the negative terminal of cell S_{B} is disconnected from node n4 because switch Sw7 is open, thereby isolating fly capacitor C_{FLY}2 from cell S_{B}.

In this configuration, cell S_{T} transfers charge to fly capacitor C_{FLY}2 if C_{FLY}2 is at a lower voltage than cell S_{T}; conversely, C_{FLY}2 transfers charge to cell S_{T} if S_{T} is at a lower voltage. Meanwhile, cell S_{B} transfers charge to fly capacitor C_{FLY}1 if C_{FLY}1 is at a lower voltage than cell S_{B}; conversely, fly capacitor C_{FLY}1 transfers charge to cell S_{B} if S_{B} is at a lower voltage.

As another example, FIG. 3D is a schematic diagram 360 of the circuit of FIG. 3B with the switches set to an opposite second state. In the second state, P1 is a logic “0” and P2 is a logic “1”, and accordingly switches Sw2, Sw4, Sw6, Sw8 are open and switches Sw1, Sw3, Sw5, Sw7 are closed. The following connections and disconnections are formed:

(1) the positive terminal of cell S_{T} is connected to node n1 through switch Sw1 and the negative terminal of cell S_{T} is connected to node n2 through switch Sw3, thereby connecting fly capacitor C_{FLY}1 across cell S_{T};

(2) the positive terminal of cell S_{B} is disconnected from node n1 because switch Sw2 is open and the negative terminal of cell S_{B} is disconnected from node n2 because switch Sw4 is open, thereby isolating fly capacitor C_{FLY}1 from cell S_{B};

(3) the positive terminal of cell S_{T} is disconnected from node n3 because switch Sw6 is open and the negative terminal of cell S_{T} is disconnected from node n4 because switch Sw8 is open, thereby disconnecting fly capacitor C_{FLY}2 from cell S_{T};

(4) the positive terminal of cell S_{B} is connected to node n3 through switch Sw5 and the negative terminal of cell S_{B} is connected to node n4 because switch Sw7 is closed, thereby connecting fly capacitor C_{FLY}2 across cell S_{B}.

In this configuration, cell S_{T} transfers charge to fly capacitor C_{FLY}1 if C_{FLY}1 is at a lower voltage than cell S_{T}; conversely, C_{FLY}1 transfers charge to cell S_{T} if S_{T} is at a lower voltage. Meanwhile, cell S_{B} transfers charge to fly capacitor C_{FLY}2 if C_{FLY}2 is at a lower voltage than cell S_{B}; conversely, fly capacitor C_{FLY}2 transfers charge to cell S_{B} if S_{B} is at a lower voltage.

A set of N−1 BCBC 302x circuits (as shown by way of example in FIGS. 3B-3D) each connected between a pair of adjacent cells in a battery pack 102 of N cells Sx, as shown in FIG. 3A, automatically recycles energy from higher voltage cells into lower voltage cells across all cells Sx in “bucket brigade” fashion under any charge condition, thus eventually balancing the entire battery pack 102. No complex external control logic is required to determine how the BCBCs 302x are to be connected, charge balancing is performed without disturbing the series connections of the cells Sx in a battery pack, and there is constant charge balancing across the entire charge range of cells Sx in a battery pack. Further note, the voltage across each BCBC 302x is only the sum of the voltages from the two bracketing cells, and accordingly, the configuration shown in FIG. 3A scales up to a large number of cells Sx without requiring increasingly larger and more expensive high voltage transistors.

Adiabatic Charge Transfer Embodiment

The efficiency of the BCBC 302x shown in FIG. 3B can be significantly improved by a slight configuration augmentation that allows the BCBC 302x to operate adiabatically. A consequence of operating in an adiabatic configuration is reduced energy loss and thus higher efficiency.

As used in this disclosure, changing the charge on a capacitor (such as by charging or discharging the fly capacitors C_{FLY}1, C_{FLY}2) adiabatically means causing an amount of charge stored in that capacitor to change by passing the charge through a non-capacitive element. A positive adiabatic change in charge on the capacitor is considered adiabatic charging while a negative adiabatic change in charge on the capacitor is considered adiabatic discharging. Examples of non-capacitive elements include inductors, magnetic elements, resistors, and combinations of such elements. An inductor is a particularly useful non-capacitive element for an adiabatic configuration of a BCBC 302x, as further described below.

In some cases, a capacitor can be charged adiabatically for part of the time and diabatically for the rest of the time. Such capacitors are considered to be adiabatically charged. Similarly, in some cases, a capacitor can be discharged adiabatically for part of the time and diabatically for the rest of the time. Such capacitors are considered to be adiabatically discharged. Diabatic charging includes all charging that is not adiabatic, and diabatic discharging includes all discharging that is not adiabatic.

As one example, FIG. 3E is a schematic of a circuit 380 for implementing an adiabatic-enabled concurrent bidirectional charge balancing circuit BCBC 302x. Similar in most respects to the circuit 320 of FIG. 3B, in the illustrated example, a first inductor L1 is coupled between the positive terminal of cell S_{T} and a node n5 connected to switches Sw1 and Sw6, and a second inductor L2 is coupled between the positive terminal of cell S_{B} and a node n7 connected to switches Sw2 and Sw5. Accordingly, the positive terminals of cell S_{T} and cell S_{B} always couple to a “top” plate of either C_{FLY}1 or C_{FLY}2 through a respective inductor L1, L2. In an alternative embodiment, the first inductor L1 may be coupled between the negative terminal of cell S_{T} and a node n6 connected to switches Sw3 and Sw8, and the second inductor L2 may be coupled between the negative terminal of cell S_{B} and a node n8 connected to switches Sw4 and Sw7. The inductors L1, L2 may be external to an IC implementation of the BCBC 302x or may be fabricated as part of the same IC. The values of the inductors L1, L2 are generally dependent on clock frequency and desired balancing time, and may be determined by circuit modeling and/or testing.

The switching and charge transfer operation of the adiabatic-enabled BCBC 302x shown in FIG. 3E is the same as the operation of the BCBC 302x shown in FIG. 3B, although more efficient. Accordingly, when switches Sw1-Sw8 are controlled by waveforms P1, P2, the switches Sw1-Sw8, fly capacitors C_{FLY}1, C_{FLY}2, and inductors L1, L2 function as a pair of interconnected adiabatic-enabled bi-phase bidirectional concurrent charge transfer circuits.

Due to the adiabatic nature of a concurrent bidirectional charge balancing circuit such as the circuit 380 of FIG. 3E, the circuit operates at very high efficiency, turning charge balancing of a battery pack into an efficient transfer of energy instead of dissipating unwanted energy as heat. This is due to the ability of the inductors L1, L2 to capture the charge redistribution losses that inherently arise when two capacitors (e.g., a cell Sx and a fly capacitor C_{FLY}n) with different voltages connect in parallel. In a first switch state (i.e., P1 is a logic “1” and P2 is a logic “0”), the voltage difference and therefore the corresponding energy difference between a connected pair of capacitors comprising a cell S_{T} and a fly capacitor C_{FLY}2 is temporarily stored in the inductor L1 that connects between them, then released to the lower-energy capacitor. At the same time, the voltage difference and therefore the corresponding energy difference between a connected pair of capacitors comprising a cell S_{B} and a fly capacitor C_{FLY}1 is temporarily stored in the inductor L2 that connects between them, then released to the lower-energy capacitor. In a second switch state (i.e., P1 is a logic “0” and P2 is a logic “1”), the energy differences between the next connected pairs of capacitors is stored in each inductor L1, L2 and then released to the corresponding lower-energy capacitor in each pair. In this way, the potential energy loss from capacitor charge redistribution is avoided or minimized.

Compared to conventional capacitive balancing circuits of the type shown in FIG. 2, which operate at no more than about 60% efficiency at high charge transfer rates, embodiments of the adiabatic-enabled BCBC 302x of FIG. 3E operated at high charge transfer rates may exhibit an efficiency in excess of about 90%—an improvement of at least 50%—and, in some cases, may exhibit an efficiency equal to or greater than about 99%. Stated another way, the circuit loss at high charge transfer rates improves from about 40% or more for conventional capacitive balancing circuits to less than about 10% for embodiments of the present invention, which is at least a 75% reduction in loss.

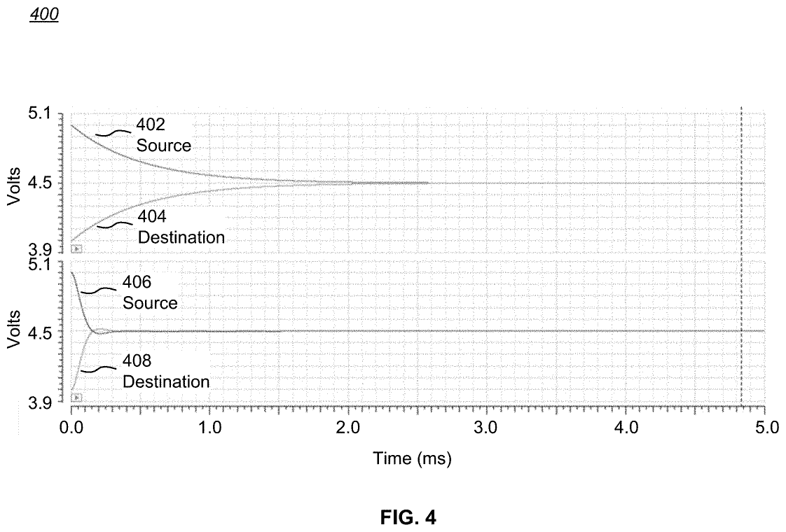

Another benefit of adiabatic-enabled concurrent bidirectional charge balancing circuits such as the adiabatic-enabled BCBC 302x of FIG. 3E is the speed of balancing compared to conventional capacitive circuits, since little energy is lost in heat while balancing at a higher charge transfer rate, and thus is more efficient. For example, FIG. 4 is a set of graphs 400 of voltage as a function of time for a conventional capacitive circuit (upper portion of the graph) and for an embodiment of the present invention (lower portion of the graph). The conventional capacitive circuit transfers excess charge from a source cell (graph line 402) to a destination cell (graph line 404) to a balanced state over a time period of about 2 mS. In contrast, an adiabatic-enabled embodiment of the present invention transfers excess charge from a source cell (graph line 406) to a destination cell (graph line 408) to a balanced state over a time period of about 0.25 mS, which is faster by a factor of about 8.

### Variant Embodiments

In some embodiments of the non-adiabatic and adiabatic concurrent bidirectional charge balancing circuits described above, it may be useful to include capacitors across the terminals of a BCBC 302x to filter out EMI and reduce noise by smoothing out switching edges. For an adiabatic-enabled BCBC 302x, such capacitors may even be necessary to support inductor current flow and prevent the voltages on nodes n5-n8 from collapsing during the Sw1-Sw8 switch deadtimes. For example, in FIG. 3E, a first capacitor C1 is coupled between node n5 and a node n6 coupled to the negative terminal of cell S_{T} (as well as to switches Sw3, Sw8) and a second capacitor C2 is coupled between node n7 and a node n8 coupled to the negative terminal of cell S_{B} (as well as to switches Sw4, Sw7). For an adiabatic-enabled BCBC 302x, the capacitors C1, C2 should be sized to be much smaller in capacitance than the fly capacitors C_{FLY}1, C_{FLY}2, such as about 10 to 100 times smaller, in order to maximize efficiency. In a specific embodiment, the capacitors C1, C2 may be about 100 nF each. The capacitors C1, C2 may be external to an IC implementation of the BCBC 302x or may be fabricated as part of the same IC.

Clocking Circuit Example

FIG. 5 is a graph 500 of non-overlapping two-phase (P1, P2) clock waveforms suitable for controlling the operation of the concurrent bidirectional charge balancing circuits of FIGS. 3A-3E. FIG. 6 is a schematic diagram of one circuit capable of generating the non-overlapping two-phase clock waveforms shown in FIG. 5. In the illustrated example, an oscillator 600 capable of outputting a suitable waveform, such as a square wave, is coupled to a pair of cross-coupled NAND gates N1, N2 (directly coupled for N1 and through a first inverter Inv0 for N2). The outputs of the NAND gates N1, N2 are coupled to respective inverters Inv1, Inv2, the outputs of which are the non-overlapping clock waveforms P1, P2 shown in FIG. 4. A typical clock frequency for P1 and P2 may be about 500 kHz.

Methods

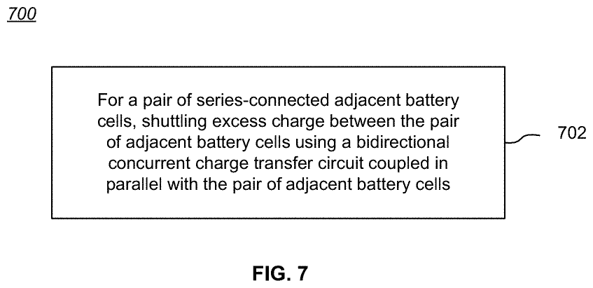

Another aspect of the invention includes methods for balancing charge (if the capacitances of each cell are equal) and/or voltage among cells in a multicell battery pack. For example, FIG. 7 is a process flow chart 700 showing a first method of bidirectionally balancing charge and/or voltage between a pair of series-connected adjacent battery cells, including shuttling excess charge between the pair of adjacent battery cells using a concurrent bidirectional charge transfer circuit coupled in parallel with such pair of adjacent battery cells (Block 702). The method provides significant efficiencies when the concurrent bidirectional charge transfer circuit operates at high charge transfer rates.

Additional aspects of the above method may include one or more of the following: wherein the concurrent bidirectional charge balancing circuit is adiabatic-enabled; wherein the concurrent bidirectional charge balancing circuit includes a pair of bi-phase bidirectional charge transfer circuits; wherein the concurrent bidirectional charge balancing circuit includes a pair of adiabatic-enabled bi-phase bidirectional charge transfer circuits; wherein the concurrent bidirectional charge balancing circuit includes a pair of adiabatic-enabled bi-phase bidirectional charge transfer circuits configured to be periodically coupled (1) to a first cell of the pair of adjacent battery cells through a first inductor, and (2) to a second cell of the pair of adjacent battery cells through a second inductor; wherein the concurrent bidirectional charge balancing circuit includes a first pair of series-connected switches Sw1, Sw2 coupled in series between a first terminal of a first cell S_{T} of the pair of adjacent battery cells and the first terminal of a second cell S_{B} of the pair of adjacent battery cells, a second pair of series-connected switches Sw5, Sw6 coupled in series between the first terminal of the first cell S_{T} and the first terminal of the second cell S_{B} and in parallel with the first pair of series-connected switches Sw1, Sw2, a third pair of series-connected switches Sw3, Sw4 coupled in series between a second terminal of the first cell S_{T} and a second terminal of the second cell S_{B}, a fourth pair of series-connected switches Sw7, Sw8 coupled in series between the second terminal of the first cell S_{T} and the second terminal of the second cell S_{B} and in parallel with the third pair of series-connected switches Sw3, Sw4, a first fly capacitor C_{FLY}1 coupled to a first node n1 between the first pair of series-connected switches Sw1, Sw2 and to a second node n2 between the third pair of series-connected switches Sw3, Sw4, a second fly capacitor C_{FLY}2 coupled to a third node n3 between the second pair of series-connected switches Sw5, Sw6 and to a fourth node n4 between the fourth pair of series-connected switches Sw7, Sw8, further including switching switches Sw1, Sw3, Sw5, and Sw7 concurrently by a first phase of a bi-phase non-overlapping clock waveform, and switching switches Sw2, Sw4, Sw6, and Sw8 concurrently by a second phase of the bi-phase non-overlapping clock waveform; wherein the concurrent bidirectional charge balancing circuit further includes a first inductor L1 coupled between either (i) the first terminal of the first cell S_{T} and a node n5 between the switch Sw1 and switch Sw6, or (ii) the second terminal of the first cell S_{T} and a node n6 between switch Sw3 and switch Sw8, and a second inductor L2 coupled between either (i) the first terminal of the second cell S_{B} and a node n7 between switch Sw2 and switch Sw5, or (ii) the second terminal of the second cell S_{B} and a node n8 between the switch Sw4 and switch Sw7; wherein the concurrent bidirectional charge balancing circuit further optionally includes a first capacitor C1 coupled between the node n5 and the node n6, and a second capacitor C2 coupled between the node n7 and the node n8; wherein the first capacitor C1 and the second capacitor C2 are about 10 to 100 times smaller in capacitance than the first fly capacitor C_{FLY}1 and the second fly capacitor C_{FLY}2; and/or wherein the switches are field effect transistor switches.

Fabrication Technologies & Options

The term “MOSFET”, as used in this disclosure, includes any field effect transistor (FET) having an insulated gate whose voltage determines the conductivity of the transistor, and encompasses insulated gates having a metal or metal-like, insulator, and/or semiconductor structure. The terms “metal” or “metal-like” include at least one electrically conductive material (such as aluminum, copper, or other metal, or highly doped polysilicon, graphene, or other electrical conductor), “insulator” includes at least one insulating material (such as silicon oxide or other dielectric material), and “semiconductor” includes at least one semiconductor material.

Various embodiments of the invention can be implemented to meet a wide variety of specifications. Unless otherwise noted above, selection of suitable component values is a matter of design choice. Various embodiments of the invention may be implemented in any suitable integrated circuit (IC) technology (including but not limited to MOSFET structures), or in hybrid or discrete circuit forms. Integrated circuit embodiments may be fabricated using any suitable substrates and processes, including but not limited to standard bulk silicon, silicon-on-insulator (SOI), and silicon-on-sapphire (SOS). Unless otherwise noted above, embodiments of the invention may be implemented in other transistor technologies such as bipolar, LDMOS, BCD, GaAs HBT, GaN HEMT, GaAs pHEMT, and MESFET technologies. However, embodiments of the invention are particularly useful when fabricated using an SOI or SOS based process, or when fabricated with processes having similar characteristics. Fabrication in CMOS using SOI or SOS processes enables circuits with low power consumption, the ability to withstand high power signals during operation due to FET stacking, good linearity, and high frequency operation (i.e., radio frequencies up to and exceeding 50 GHz). Monolithic IC implementation is particularly useful since parasitic capacitances generally can be kept low (or at a minimum, kept uniform across all units, permitting them to be compensated) by careful design.

Voltage levels may be adjusted, and/or voltage and/or logic signal polarities reversed, depending on a particular specification and/or implementing technology (e.g., NMOS, PMOS, or CMOS, and enhancement mode or depletion mode transistor devices). Component voltage, current, and power handling capabilities may be adapted as needed, for example, by adjusting device sizes, serially “stacking” components (particularly FETs) to withstand greater voltages, and/or using multiple components in parallel to handle greater currents. Additional circuit components may be added to enhance the capabilities of the disclosed circuits and/or to provide additional functionality without significantly altering the functionality of the disclosed circuits.

Circuits and devices in accordance with the present invention may be used alone or in combination with other components, circuits, and devices. Embodiments of the present invention may be fabricated as integrated circuits (ICs), which may be encased in IC packages and/or or modules for ease of handling, manufacture, and/or improved performance. In particular, IC embodiments of this invention are often used in modules in which one or more of such ICs are combined with other circuit blocks (e.g., filters, passive components, and possibly additional ICs) into one package. The ICs and/or modules are then typically combined with other components, often on a printed circuit board, to form an end product such as a cellular telephone, laptop computer, or electronic tablet, or to form a higher level module which may be used in a wide variety of products, such as vehicles, test equipment, medical devices, etc. Through various configurations of modules and assemblies, such ICs typically enable a mode of communication, often wireless communication.

### CONCLUSION

A number of embodiments of the invention have been described. It is to be understood that various modifications may be made without departing from the spirit and scope of the invention. For example, some of the steps described above may be order independent, and thus can be performed in an order different from that described. Further, some of the steps described above may be optional. Various activities described with respect to the methods identified above can be executed in repetitive, serial, or parallel fashion.

It is to be understood that the foregoing description is intended to illustrate and not to limit the scope of the invention, which is defined by the scope of the following claims, and that other embodiments are within the scope of the claims. In particular, the scope of the invention includes any and all feasible combinations of one or more of the processes, machines, manufactures, or compositions of matter set forth in the claims below. (Note that the parenthetical labels for claim elements are for ease of referring to such elements, and do not in themselves indicate a particular required ordering or enumeration of elements; further, such labels may be reused in dependent claims as references to additional elements without being regarded as starting a conflicting labeling sequence).

What is claimed is:

1. A circuit architecture for balancing charge and/or voltage among at least two series-connected cells in a battery pack, including, for each pair of adjacent battery cells in the battery pack, a concurrent bidirectional charge balancing circuit coupled in parallel with such pair of adjacent battery cells, each concurrent bidirectional charge balancing circuit configured to shuttle excess charge between the pair of adjacent battery cells.

2. The invention of claim 1, wherein the concurrent bidirectional charge balancing circuit is adiabatic-enabled.

3. The invention of claim 1, wherein the concurrent bidirectional charge balancing circuit includes a pair of bi-phase bidirectional charge transfer circuits.

4. The invention of claim 1, wherein the concurrent bidirectional charge balancing circuit includes a pair of adiabatic-enabled bi-phase bidirectional charge transfer circuits.

5. The invention of claim 1, wherein the concurrent bidirectional charge balancing circuit includes a pair of adiabatic-enabled bi-phase bidirectional charge transfer circuits each configured to be periodically coupled (1) to a first cell of the pair of adjacent battery cells through a first inductor, and (2) to a second cell of the pair of adjacent battery cells through a second inductor.

6. The invention of claim 1, wherein the concurrent bidirectional charge balancing circuit includes:
(a) a first pair of series-connected switches Sw1, Sw2 coupled in series between a first terminal of a first cell S_{T} of the pair of adjacent battery cells and a first terminal of a second cell S_{B} of the pair of adjacent battery cells;
(b) a second pair of series-connected switches Sw5, Sw6 coupled in series between the first terminal of the first cell S_{T} and the first terminal of the second cell S_{B} and in parallel with the first pair of series-connected switches Sw1, Sw2;
(c) a third pair of series-connected switches Sw3, Sw4 coupled in series between a second terminal of the first cell S_{T} and a second terminal of the second cell S_{B};
(d) a fourth pair of series-connected switches Sw7, Sw8 coupled in series between the second terminal of the first cell S_{T} and the second terminal of the second cell S_{B} and in parallel with the third pair of series-connected switches Sw3, Sw4;
(e) a first fly capacitor C_{FLY}1 coupled to a first node n1 between the first pair of series-connected switches Sw1, Sw2 and to a second node n2 between the third pair of series-connected switches Sw3, Sw4;
(f) a second fly capacitor C_{FLY}2 coupled to a third node n3 between the second pair of series-connected switches Sw5, Sw6 and to a fourth node n4 between the fourth pair of series-connected switches Sw7, Sw8;
wherein switches Sw1, Sw3, Sw5, and Sw7 are concurrently switched by a first phase of a bi-phase non-overlapping clock waveform, and switches Sw2, Sw4, Sw6, and Sw8 are concurrently switched by a second phase of the bi-phase non-overlapping clock waveform.

7. The invention of claim 6, further including:
(a) a first inductor L1 coupled between either (i) the first terminal of the first cell S_{T} and a node n5 between the switch Sw1 and switch Sw6, or (ii) the second terminal of the first cell S_{T} and a node n6 between switch Sw3 and switch Sw8; and
(b) a second inductor L2 coupled between either (i) the first terminal of the second cell S_{B} and a node n7 between switch Sw2 and switch Sw5, or (ii) the second terminal of the second cell S_{B} and a node n8 between the switch Sw4 and switch Sw7.

8. The invention of claim 7, further including:
(a) a first capacitor C1 coupled between the node n5 and the node n6; and
(b) a second capacitor C2 coupled between the node n7 and the node n8.

9. The invention of claim 8, wherein the first capacitor C1 and the second capacitor C2 are about 10 to 100 times smaller in capacitance than the first fly capacitor C_{FLY}1 and the second fly capacitor C_{FLY}2.

10. The invention of claim 6, wherein the switches are field effect transistor switches.

11. A circuit architecture for balancing charge among at least two series-connected cells in a battery pack, including, for each pair of adjacent battery cells in the battery pack, a concurrent bidirectional charge balancing circuit coupled in parallel with such pair of adjacent battery cells, each concurrent bidirectional charge balancing circuit configured to shuttle excess charge between such pair of adjacent battery cells with at least about 90% efficiency when operating at high charge transfer rates.

12. A method of balancing charge and/or voltage between a pair of series-connected adjacent battery cells, including shuttling excess charge between the pair of adjacent battery cells using a concurrent bidirectional charge transfer circuit coupled in parallel with the pair of adjacent battery cells.

13. The method of claim 12, wherein the concurrent bidirectional charge balancing circuit is adiabatic-enabled.

14. The method of claim 12, wherein the concurrent bidirectional charge balancing circuit includes a pair of bi-phase bidirectional charge transfer circuits.

15. The method of claim 12, wherein the concurrent bidirectional charge balancing circuit includes a pair of adiabatic-enabled bi-phase bidirectional charge transfer circuits.

16. The method of claim 12, wherein the concurrent bidirectional charge balancing circuit includes a pair of adiabatic-enabled bi-phase bidirectional charge transfer circuits configured to be periodically coupled (1) to a first cell of the pair of adjacent battery cells through a first inductor, and (2) to a second cell of the pair of adjacent battery cells through a second inductor.

17. The method of claim 12, wherein the concurrent bidirectional charge balancing circuit includes:
(a) a first pair of series-connected switches Sw1, Sw2 coupled in series between a first terminal of a first cell S_{T} of the pair of adjacent battery cells and a first terminal of a second cell S_{B} of the pair of adjacent battery cells;
(b) a second pair of series-connected switches Sw5, Sw6 coupled in series between the first terminal of the first cell S_{T} and the first terminal of the second cell S_{B} and in parallel with the first pair of series-connected switches Sw1, Sw2;
(c) a third pair of series-connected switches Sw3, Sw4 coupled in series between a second terminal of the first cell S_{T} and a second terminal of the second cell S_{B};
(d) a fourth pair of series-connected switches Sw7, Sw8 coupled in series between the second terminal of the first cell S_{T} and the second terminal of the second cell S_{B} and in parallel with the third pair of series-connected switches Sw3, Sw4;
(e) a first fly capacitor C_{FLY}1 coupled to a first node n1 between the first pair of series-connected switches Sw1, Sw2 and to a second node n2 between the third pair of series-connected switches Sw3, Sw4;
(f) a second fly capacitor C_{FLY}2 coupled to a third node n3 between the second pair of series-connected switches Sw5, Sw6 and to a fourth node n4 between the fourth pair of series-connected switches Sw7, Sw8;
further including switching switches Sw1, Sw3, Sw5, and Sw7 concurrently by a first phase of a bi-phase non-overlapping clock waveform, and switching switches Sw2, Sw4, Sw6, and Sw8 concurrently by a second phase of the bi-phase non-overlapping clock waveform.

18. The method of claim 17, wherein the concurrent bidirectional charge balancing circuit further includes:
(a) a first inductor L1 coupled between either (i) the first terminal of the first cell S_{T} and a node n5 between the switch Sw1 and switch Sw6, or (ii) the second terminal of the first cell S_{T} and a node n6 between switch Sw3 and switch Sw8; and
(b) a second inductor L2 coupled between either (i) the first terminal of the second cell S_{B} and a node n7 between switch Sw2 and switch Sw5, or (ii) the second terminal of the second cell S_{B} and a node n8 between the switch Sw4 and switch Sw7.

19. The method of claim 18, wherein the concurrent bidirectional charge balancing circuit further includes:
(a) a first capacitor C1 coupled between the node n5 and the node n6; and
(b) a second capacitor C2 coupled between the node n7 and the node n8.

20. The method of claim 19, wherein the first capacitor C1 and the second capacitor C2 are about 10 to 100 times smaller in capacitance than the first fly capacitor C_{FLY}1 and the second fly capacitor C_{FLY}2.

21. The method of claim 17, wherein the switches are field effect transistor switches.
